(19) United States
(12) Patent Application Publication
(10) Pub. No.: US 2011/0268649 A1
(43) Pub. Date: Nov. 3, 2011

(54) CATALYST COMPRISING RUTHENIUM AND NICKEL FOR THE OXIDATION OF HYDROGEN CHLORIDE

(75) Inventors: Guido Henze, Buerstadt (DE); Heiko Urtel, Bobenheim-Roxheim (DE); Martin Sesing, Waldsee (DE); Martin Karches, Neustadt (DE); Thorsten Von Fehren, Buerstadt (DE); Toni Kustura, Carlsberg (DE)

(73) Assignee: BASF SE, Ludwigshafen (DE)

(21) Appl. No.: 13/142,462

(22) PCT Filed: Dec. 22, 2009
(86) PCT No.: PCT/EP09/67720

§ 371 Date: Jun. 28, 2011

(30) Foreign Application Priority Data
Dec. 30, 2008 (EP) 08173107.7

(51) Int. Cl. C01B 7/04

(52) U.S. Cl. 423/502

(57) ABSTRACT

Catalyst for gas-phase reactions which has a high mechanical stability and comprises one or more active metals on a support comprising aluminum oxide as support material, wherein the aluminum oxide component of the support consists essentially of alpha-aluminum oxide.

Particularly preferred catalysts according to the invention comprise
a) from 0.001 to 10% by weight of ruthenium, copper and/or gold,
b) from 0 to 5% by weight of one or more alkaline earth metals,
c) from 0 to 5% by weight of one or more alkali metals,
d) from 0 to 10% by weight of one or more rare earth metals,
e) from 0 to 10% by weight of one or more further metals selected from the group consisting of palladium, platinum, iridium and rhenium,
   in each case based on the total weight of the catalyst, on the alpha-Al₂O₃ support.

The catalysts are preferably used in the oxidation of hydrogen chloride (Deacon reaction).

The invention relates to a catalyst for the catalytic oxidation of hydrogen chloride to chlorine by means of oxygen and a process for the catalytic oxidation of hydrogen chloride using the catalyst.

In the process developed by Deacon in 1868 for the catalytic oxidation of hydrogen chloride, hydrogen chloride is oxidized to chlorine by means of oxygen in an exothermic equilibrium reaction. The conversion of hydrogen chloride into chlorine enables the production of chlorine to be decoupled from the production of sodium hydroxide by chloralkali electrolysis. Such decoupling is attractive since the world demand for chlorine is growing faster than the demand for sodium hydroxide. In addition, hydrogen chloride is obtained in large amounts as coproduct in, for example, phosgenation reactions, for instance in isocyanate production.

EP-A 0 743 277 discloses a process for preparing chlorine by catalytic oxidation of hydrogen chloride, in which a ruthenium-comprising supported catalyst is used. Here, ruthenium is applied in the form of ruthenium chloride, ruthenium oxychlorides, chlororuthenate complexes, ruthenium hydroxide, ruthenium-amine complexes or further ruthenium complexes to the support. The catalyst can comprise palladium, copper, chromium, vanadium, manganese, alkali metals, alkaline earth metals and rare earth metals as further metals.

According to GB 1,046,313, ruthenium(III) chloride on aluminum oxide is used as catalyst in a process for the catalytic oxidation of hydrogen chloride.

DE 10 2005 040286 A1 discloses a mechanically stable catalyst comprising
a) from 0.001 to 10% by weight of ruthenium, copper and/or gold,
b) from 0 to 5% by weight of one or more alkaline earth metals,
c) from 0 to 5% by weight of one or more alkali metals,
d) from 0 to 10% by weight of one or more rare earth metals,
e) from 0 to 10% by weight of one or more further metals selected from the group consisting of palladium, platinum, osmium, iridium, silver and rhenium,
   on alpha-aluminum oxide as support for the oxidation of hydrogen chloride.

As promoters suitable for doping, mention is made of alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof, also titanium, manganese, molybdenum and tin.

The catalysts of the prior art are still capable of improvement in terms of their catalytic activity and long-term stability. Particularly after a prolonged period of operation of more than 100 hours, the activity of the known catalysts decreases significantly.

It is an object of the present invention to provide catalysts for the catalytic oxidation of hydrogen chloride which have improved catalytic activity and long-term stability.

This object is achieved by a catalyst comprising ruthenium on a support for the catalytic oxidation of hydrogen chloride to chlorine by means of oxygen, wherein the catalyst comprises from 0.1 to 10% by weight of nickel as dopant.

It has been found that a ruthenium-comprising catalyst doped with nickel has a higher activity than a catalyst without nickel. It is presumed that this activity increase is attributable firstly to the promoting properties of nickel chloride and also to better dispersion of the active component on the surface of the catalyst brought about by the nickel chloride. Thus, ruthenium is present as RuO₂ crystallites having a crystallite size of <7 nm on the catalyst of the invention in fresh or regenerated form. The crystallite size is determined via the width at half height of the reflection of the species in the XRD pattern.

Suitable support materials are silicon dioxide, aluminum oxide, titanium dioxide or zirconium dioxide. Preferred supports are silicon dioxide, aluminum oxide and titanium dioxide, particularly preferably aluminum oxide and titanium dioxide, very particularly preferably alpha-aluminum oxide.

In general, the catalyst of the invention is used at a temperature of above 200° C., preferably above 320° C., particularly preferably above 350° C., for carrying out gas-phase reactions. However, the reaction temperature is generally not more than 600° C., preferably not more than 500° C.

As promoters, the catalyst of the invention can comprise not only nickel but also further metals. These are usually comprised in amounts of up to 10% by weight, based on the weight of the catalyst, in the catalyst.

The ruthenium- and nickel-comprising catalysts of the invention for the catalytic oxidation of hydrogen chloride can additionally comprise compounds of one or more other noble metals selected from among palladium, platinum, iridium and rhenium. The catalysts can also be doped with one or more further metals. Suitable promoters for doping are alkali metals such as lithium, sodium, potassium, rubidium and cesium, preferably lithium, sodium and potassium, particularly preferably potassium, alkaline earth metals such as magnesium, strontium and barium, preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof, also titanium, manganese, molybdenum and tin.

Catalysts according to the invention which are preferred for the oxidation of hydrogen chloride comprise
a) from 0.1 to 10% by weight of ruthenium,
b) from 0.1 to 10% by weight of nickel,
c) from 0 to 5% by weight of one or more alkaline earth metals,
d) from 0 to 5% by weight of one or more alkali metals,
e) from 0 to 5% by weight of one or more rare earth metals,
f) from 0 to 5% by weight of one or more further metals selected from the group consisting of palladium, platinum, iridium and rhenium,
   in each case based on the total weight of the catalyst. The proportions by weight are based on the weight of the metal, even when the metals are generally present in oxidic or chloridic form on the support.

In general, the total content of further metals c) to f) present in addition to ruthenium and nickel is not more than 5% by weight.

The catalyst of the invention very particularly preferably comprises from 0.5 to 5% by weight of ruthenium and from 0.5 to 5% by weight of nickel, based on the weight of the catalyst. In a specific embodiment, the catalyst of the invention comprises from about 1 to 3% by weight of ruthenium and from 1 to 3.5% by weight of nickel on alpha-aluminum oxide as support and no further active metals or promoter metals, with ruthenium being present as RuO₂.

The catalysts of the invention are obtained by impregnating the support material with aqueous solutions of salts of the metals. The metals are usually applied as aqueous solutions of their chlorides, oxychlorides or oxides to the support. Shaping of the catalyst can be carried out after or preferably before impregnation of the support material. The catalysts of the invention are also used as fluidized-bed catalysts in the form of powder having an average particle size of 10-200 μm. As fixed-bed catalysts, they are generally used in the form of shaped catalyst bodies.

The supported ruthenium catalysts can, for example, be obtained by impregnating the support material with aqueous solutions of RuCl₃ and NiCl₂ and, if appropriate, the further promoters for doping, preferably in the form of their chlorides. Shaping of the catalyst can be carried out after or preferably before impregnation of the support material.

The shaped bodies or powders can subsequently be dried and optionally calcined at temperatures of from 100 to 400° C., preferably from 100 to 300° C., for example under a nitrogen, argon or air atmosphere. The shaped bodies or powders are preferably firstly dried at from 100 to 150° C. and subsequently calcined at from 200 to 400° C.

The invention also provides a process for producing catalysts by impregnating the support materials with one or more metal salt solutions comprising the active metal or metals and, if appropriate, one or more promoter metals and drying and calcining the impregnated support. Shaping to give shaped catalyst particles can be carried out before or after impregnation. The catalyst of the invention can also be used in powder form.

Suitable shaped catalyst bodies are any shapes, with preference being given to pellets, rings, cylinders, stars, wagon wheels or spheres, particularly preferably rings, cylinders or star extrudates.

The specific surface area of the particularly preferred alpha-aluminum oxide support prior to deposition of the metal salts is generally in the range from 0.1 to 10 m²/g. Alpha-aluminum oxide can be prepared by heating gamma-aluminum oxide to temperatures above 1000° C. and is preferably prepared in this way. It is generally calcined for from 2 to 24 hours.

The present invention also provides a process for the catalytic oxidation of hydrogen chloride to chlorine by means of oxygen over the catalyst of the invention.

For this purpose, a hydrogen chloride stream and an oxygen-comprising stream are fed into an oxidation zone and hydrogen chloride is partly oxidized to chlorine in the presence of the catalyst, giving a product gas stream comprising chlorine, unreacted oxygen, unreacted hydrogen chloride and water vapor. The hydrogen chloride stream, which can originate from a plant for the preparation of isocyanates, can comprise impurities such as phosgene and carbon monoxide.

Usual reaction temperatures are in the range from 150 to 500° C., and usual reaction pressures are in the range from 1 to 25 bar, for example 4 bar. The reaction temperature is preferably >300° C., particularly preferably in the range from 350° C. to 400° C. Furthermore, it is advantageous to use oxygen in superstoichiometric amounts. It is usual to use, for example, a 1.5- to four-fold excess of oxygen. Since no decreases in selectivity have to be feared, it can be economically advantageous to work at relatively high pressures and correspondingly at residence times longer than those at atmospheric pressure.

Usual reaction apparatuses in which the catalytic oxidation of hydrogen chloride according to the invention is carried out are fixed-bed or fluid-bed reactors. The oxidation of hydrogen chloride can be carried out in one or more stages.

The catalyst bed or the fluidized bed of catalysts can comprise, in addition to the catalyst of the invention, further suitable catalysts or additional inert material.

The catalytic oxidation of hydrogen chloride can be carried out adiabatically or preferably isothermally or approximately isothermally, batchwise or preferably continuously as a fluidized-bed or fixed-bed process, preferably as a fixed-bed process, particularly preferably in shell-and-tube reactors, at reactor temperatures of from 200 to 500° C., preferably from 300 to 400° C., and a pressure of from 1 to 25 bar, preferably from 1 to 5 bar.

In the isothermal or approximately isothermal mode of operation, it is also possible to use a plurality of, for example from 2 to 10, preferably from 2 to 6, particularly preferably from 2 to 5, in particular 2 or 3, reactors connected in series with additional intermediate cooling. The oxygen can either all be introduced together with the hydrogen chloride upstream of the first reactor or its addition can be distributed over the various reactors. This series arrangement of individual reactors can also be combined in one apparatus.

One embodiment of the fixed-bed process comprises using a structured catalyst bed in which the catalyst activity increases in the flow direction. Such structuring of the catalyst bed can be effected by different impregnation of the catalyst support with active composition or by different dilution of the catalyst bed with an inert material. As inert material, it is possible to use, for example, rings, cylinders or spheres of titanium dioxide, zirconium dioxide or mixtures thereof, aluminum oxide, steatite, ceramic, glass, graphite or stainless steel. The inert material preferably has similar external dimensions as the shaped catalyst bodies.

The conversion of hydrogen chloride in a single pass can be limited to from 15 to 90%, preferably from 40 to 85%. Unreacted hydrogen chloride can, after having been separated off, be partly or entirely recirculated to the catalytic oxidation of hydrogen chloride. The volume ratio of hydrogen chloride to oxygen at the reactor inlet is generally in the range from 1:1 to 20:1, preferably from 1.5:1 to 8:1, particularly preferably from 1.5:1 to 5:1.

The chlorine formed can subsequently be separated off in a customary manner from the product gas stream obtained in the catalytic oxidation of hydrogen chloride. The separation usually comprises a plurality of steps, namely the separation and, if appropriate, recirculation of unreacted hydrogen chloride from the product gas stream to the catalytic oxidation of hydrogen chloride, drying of the residual gas stream consisting essentially of chlorine and oxygen and the separation of chlorine from the dried stream.

A fluidized-bed catalyst which is operated in a reactor made of nickel-comprising steels (e.g. HC4, Inconel 600, etc.) results in release of NiCl₂ by the reactor because of corrosion and erosion during the Deacon reaction. This NiCl₂ formed partly deposits on the catalyst surface. Thus, a catalyst comprises about 2.5% by weight of Ni as chloride after about 8000 hours of operation. If the RuO₂ of such a catalyst is reduced to elemental ruthenium or RuCl₃ by means of a reducing agent such as H₂ or HCl in the gas phase, this can be leached from the support by means of an aqueous HCl solution. The resulting solution comprises the soluble ruthenium components together with the nickel chloride. If this solution is concentrated, it is possible to prepare a new, fresh catalyst which simultaneously comprises nickel in the form of NiCl₂ as dopant.

It is thus also possible to produce a nickel-doped catalyst comprising ruthenium according to the invention from a used catalyst comprising ruthenium oxide and nickel chloride by a process comprising the steps:
a) the catalyst comprising ruthenium oxide is reduced in a gas stream comprising hydrogen chloride and, if appropriate, an inert gas at a temperature of from 300 to 500° C.;
b) the reduced catalyst from step a) is treated with hydrochloric acid in the presence of an oxygen-comprising gas, with the metallic ruthenium present on the support being dissolved as ruthenium chloride and being obtained as aqueous ruthenium chloride solution;
c) if appropriate, the solution comprising ruthenium chloride and nickel in dissolved form from step b) is concentrated;
d) the solution comprising ruthenium chloride and nickel in dissolved form is used for producing a fresh catalyst.

A used, ruthenium-comprising hydrogen chloride oxidation catalyst can also be regenerated by:
a) reduction of the catalyst in a gas stream comprising hydrogen chloride and, if appropriate, an inert gas at a temperature of from 300 to 500° C.,
b) recalcination of the catalyst in an oxygen-comprising gas stream at a temperature of from 200 to 450° C.

It has been found that RuO₂ can be reduced by means of hydrogen chloride. It is assumed that the reduction occurs via RuCl₃ to elemental ruthenium. Thus, if a partially deactivated catalyst comprising ruthenium oxide is treated with hydrogen chloride, ruthenium oxide is presumably reduced quantitatively to ruthenium after a sufficiently long treatment time. As a result of this reduction, the RuO₂ crystallites are destroyed and the elemental ruthenium, which can be present as elemental ruthenium, as a mixture of ruthenium chloride and elemental ruthenium or as ruthenium chloride, is redispersed on the support. After the reduction, the elemental ruthenium can be reoxidized by means of an oxygen-comprising gas, for example air, to the catalytically active RuO₂. It has been found that the catalyst obtained in this way once again has approximately the activity of the fresh catalyst. An advantage of the process is that the catalyst can be regenerated in situ in the reactor and does not have to be removed from the reactor.

If the used catalyst laden with nickel chloride is regenerated in situ, a catalyst which is doped with nickel chloride and is 80% more active than the fresh catalyst originally used is obtained. This increase in activity can be explained firstly by the promoting properties of nickel chloride and also by better dispersion of the active component on the surface of the catalyst brought about by the nickel chloride.

The invention is illustrated by the following examples.

### EXAMPLES

### Example 1

### Comparative Catalyst without Dopant

100 g of α-Al₂O₃ (powder, average diameter d=50 μm) are impregnated with 36 ml of an aqueous ruthenium chloride solution (4.2% based on ruthenium) in a rotating glass flask. The moist solid is dried at 120° C. for 16 hours. The dry solid resulting therefrom is calcined at 380° C. in air for 2 hours.

### Example 2

50 g of α-Al₂O₃ (powder, average diameter d=50 μm) are impregnated with 18 ml of an aqueous solution of ruthenium chloride (4.2% based on ruthenium) and nickel chloride (5.6% based on nickel) in a rotating glass flask. The moist solid is dried at 120° C. for 16 hours. The dry solid resulting therefrom is calcined at 380° C. in air for 2 hours. The catalyst comprises 2% by weight of Ni as dopant.

### Example 3

50 g of α-Al₂O₃ (powder, average diameter d=50 μm) are impregnated with 18 ml of an aqueous solution of ruthenium chloride (4.2% based on ruthenium) and nickel chloride (8.3% based on nickel) in a rotating glass flask. The moist solid is dried at 120° C. for 16 hours. The dry solid resulting therefrom is calcined at 380° C. in air for 2 hours. The catalyst comprises 3% by weight of Ni as dopant.

### Example 4

50 g of α-Al₂O₃ (powder, average diameter d=50 μm) are impregnated with 18 ml of an aqueous solution of nickel chloride (5.6% based on nickel) in a rotating glass flask. The moist solid is dried at 120° C. for 16 hours. The dry solid resulting therefrom is calcined at 380° C. in air for 2 hours. The solid obtained in this way is subsequently impregnated with 18 ml of an aqueous solution of ruthenium chloride (4.2% based on ruthenium) in a rotating glass flask. The moist solid is dried at 120° C. for 16 hours. The dry solid resulting therefrom is calcined at 380° C. in air for 2 hours. The catalyst comprises 2% by weight of Ni as dopant.

### Example 5

50 g of α-Al₂O₃ (powder, average diameter d=50 μm) are impregnated with 18 ml of an aqueous solution of nickel chloride (8.3% based on nickel) in a rotating glass flask. The moist solid is dried at 120° C. for 16 hours. The dry solid resulting therefrom is calcined at 380° C. in air for 2 hours. The solid obtained in this way is subsequently impregnated with 18 ml of an aqueous solution of ruthenium chloride (4.2% based on ruthenium) in a rotating glass flask. The moist solid is dried at 120° C. for 16 hours. The dry solid resulting therefrom is calcined at 380° C. in air for 2 hours. The catalyst comprises 3% by weight of Ni as dopant.

### Example 6

50 g of α-Al₂O₃ (powder, average diameter d=50 μm) are impregnated with 18 ml of an aqueous solution of ruthenium chloride (4.2% based on ruthenium) in a rotating glass flask. The moist solid is dried at 120° C. for 16 hours. The dry solid resulting therefrom is subsequently impregnated with 18 ml of an aqueous solution of nickel chloride (5.6% based on nickel) in a rotating glass flask. The moist solid is dried at 120° C. for 16 hours. The dry solid resulting therefrom is calcined at 380° C. in air for 2 hours. The catalyst comprises 2% by weight of Ni as dopant.

### Example 7

50 g of α-Al₂O₃ (powder, average diameter d=50 μm) are impregnated with 18 ml of an aqueous solution of ruthenium chloride (8.3% based on ruthenium) in a rotating glass flask. The moist solid is dried at 120° C. for 16 hours. The dry solid resulting therefrom is subsequently impregnated with 18 ml of an aqueous solution of nickel chloride (5.6% based on nickel) in a rotating glass flask. The moist solid is dried at 120° C. for 16 hours. The dry solid resulting therefrom is calcined at 380° C. in air for 2 hours. The catalyst comprises 3% by weight of Ni as dopant.

### Example 8

The abovementioned catalysts were tested to determine their activity and the long-term stability:

2 g of the catalyst are mixed with 118 g of α-Al₂O₃ and 9.0 standard l/h of HCl and 4.5 standard l/h of O₂ are passed through the mixture at 360° C. from the bottom upwards via a glass frit in a fluidized-bed reactor (d=29 mm; height of the fluidized bed: from 20 to 25 cm), and the HCl conversion is determined by passing the resulting gas stream into a potassium iodide solution and subsequently titrating the iodine formed with a sodium thiosulfate solution. The following conversions and activities calculated therefrom are obtained:

TABLE 1

| | HCl conversion | Activity |
|---|---|---|
| Catalyst | [%] | [−] |
| Example 1 | 37.7 | 1.9 |
| (comparison) | | |
| Example 2 | 47.3 | 2.7 |
| Example 3 | 44.8 | 2.5 |
| Example 4 | 47.1 | 2.7 |
| Example 5 | 44.7 | 2.5 |
| Example 6 | 47.2 | 2.7 |
| Example 7 | 44.7 | 2.5 |

Since the order of impregnation in the laboratory preparation is not critical to the initial activity of the catalyst, only the catalysts from examples 1, 2 and 3 were tested for long-term stability. The method by which they are produced is the preferred method for industrial catalyst production since the catalyst can be prepared in only one impregnation step.

600 g of the catalysts have 195 standard l·h⁻¹ of HCl and 97.5 standard l·h⁻¹ of O₂ passed through them at 400° C. in a fluidized-bed reactor having a diameter of 44 mm, a height of 990 mm and a bed height of from 300 to 350 mm. The catalyst is present in the form of a powder having an average diameter of 50 microns (d₅₀). A hydrogen chloride conversion of 61% is obtained here. The catalysts are operated in the range from 360 to 380° C. After particular running times, catalyst samples are taken. These are tested in terms of conversion and activity under the abovementioned conditions.

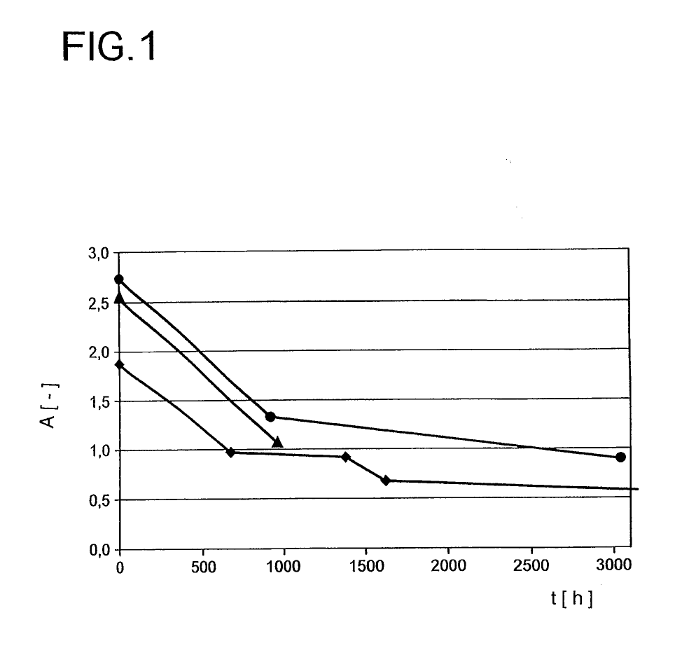

The results are shown in FIG. 1. The activity A (ordinate) is drawn against the running time t in hours (abscissa) for an undoped catalyst (lozenges), a catalyst doped with 2% nickel in the form of nickel chloride (circles) and a catalyst doped with 3% nickel in the form of nickel chlorides (triangles). The nickel-doped catalysts have a higher activity than the undoped catalyst both in the fresh state and in the used state.

### Example 9

585 g of a used and deactivated fluidized-bed catalyst comprising 2% by weight of RuO₂ on alpha-Al₂O₃ (average diameter (d₅₀): 50 μm) and, as a result of corrosion and erosion of the nickel-comprising reactor, 2.5% by weight of nickel chloride is treated with 100 standard 1/h of gaseous HCl at 430° C. in the fluidized-bed reactor described in example 1 for 70 hours. The reduced catalyst obtained in this way is treated with 2000 ml of a 20% strength HCl solution at 100° C. with vigorous stirring in a 2500 ml glass reactor for 96 hours. During the entire treatment time, 20 standard l/h of air are bubbled in. The supernatant Ru- and Ni-comprising solution is separated from the solid (support) by filtration and the filter cake is washed with 500 ml of water. The combined aqueous phases comprise >98% of the ruthenium and the nickel. Evaporation of part of this solution to 18 ml gives a solution comprising 4.2% by weight of ruthenium and 7.0% by weight of nickel. This is sprayed onto 50 g of α-Al₂O₃ (powder, average diameter (d₅₀): 50 μm) in a rotating glass flask and the moist solid is subsequently dried at 120° C. for 16 hours. The dried solid is subsequently calcined at 380° C. in air for 2 hours.

2 g of this catalyst are mixed with 118 g of α-Al₂O₃ and 9.0 standard l/h of HCl and 4.5 standard l/h of O₂ are passed through the mixture at 360° C. from the bottom upward via a glass frit in a fluidized-bed reactor (d=29 mm; height of the fluidized bed: from 20 to 25 cm) and the HCl conversion is determined by passing the resulting gas stream into a potassium iodide solution and subsequently titrating the iodine formed with a sodium thiosulfate solution. An HCl conversion of 40.0% is found. A comparable catalyst prepared analogously from a fresh ruthenium chloride solution which is free of nickel gives a conversion of 37.7%.

### Example 10

21 kg of the used catalyst from example 9 (RuO₂ on α-Al₂O₃ comprising 2.5% by weight of nickel chloride) have 10.5 kg·h⁻¹ of HCl, 4.6 kg·h⁻¹ of O₂ and 0.9 kg·h⁻¹ of N₂ passed through them at 400° C. in a fluidized-bed reactor having a diameter of 108 mm, a height of from 4 to 4.5 m and a bed height of from 2.5 to 3 m. The catalyst is present in the form of a powder having an average diameter of 50 microns (d₅₀). An HCl conversion of 77% is obtained here. The oxygen is then switched off and replaced by 10.0 kg·h⁻¹ of HCl at 400° C. for 20 hours. After 20 hours, the catalyst is recalcined at 400° C. under 2.0 kg·h⁻¹ of O₂ and 8.0 kg·h⁻¹ of N₂ for 30 minutes and thus reactivated. After this treatment, the catalyst displays an HCl conversion of 84% at 400° C. when 10.5 kg·h⁻¹ of HCl, 4.6 kg·h⁻¹ of O₂ and 0.9 kg·h⁻¹ of N₂ are passed through it.

1. A catalyst comprising ruthenium on a support for the catalytic oxidation of hydrogen chloride to chlorine by means of oxygen, wherein the catalyst comprises from 0.1 to 10% by weight of nickel as dopant.

2. The catalyst according to claim 1, wherein the support consists essentially of alpha-aluminum oxide.

3. The catalyst according to either claim 1 or 2 comprising
a) from 0.1 to 10% by weight of ruthenium,
b) from 0.1 to 10% by weight of nickel,
c) from 0 to 5% by weight of one or more alkaline earth metals,
d) from 0 to 5% by weight of one or more alkali metals,
e) from 0 to 5% by weight of one or more rare earth metals,
f) from 0 to 5% by weight of one or more further metals selected from the group consisting of palladium, platinum, iridium and rhenium,
in each case based on the total weight of the catalyst.

4. A process for producing catalysts according to any of claims 1 to 3 by impregnating the support with one or more metal salt solutions comprising ruthenium, nickel and, if appropriate, one or more further promoter metals and drying and calcining the impregnated support, with shaping to give shaped catalyst particles being able, if appropriate, to be carried out before or after impregnation.

5. A process for the catalytic oxidation of hydrogen chloride to chlorine by means of oxygen over a catalyst bed comprising catalyst particles composed of the catalyst according to any of claims 1 to 4.

6. The process according to claim 5, wherein the catalyst bed is a fixed bed or a fluidized bed.
